(19) United States
(12) Patent Application Publication
(10) Pub. No.: US 2022/0331077 A1
(43) Pub. Date: Oct. 20, 2022

(54) Oral Hygiene Device

(71) Applicant: Andres Giro Teixido, Miami, FL (US)

(72) Inventor: Andres Giro Teixido, Miami, FL (US)

(21) Appl. No.: 17/604,431

(22) PCT Filed: Apr. 17, 2020
(86) PCT No.: PCT/ES2020/070247

§ 371 Date: Apr. 14, 2022

(30) Foreign Application Priority Data
Apr. 18, 2019 (ES) U201930628
Aug. 29, 2019 (ES) U201931421
Apr. 15, 2020 (ES) U201930644

(51) Int. Cl. A61C 15/04; A46B 11/00

(52) U.S. Cl. CPC A61C 15/046; A46B 11/001; A61C 19/063

(57) ABSTRACT

An oral hygiene device, which comprises a main body not provided with a region forming a handle, with dimensions that allow the device to be completely inserted into the mouth area of a user, said main body (11, 21, 31, 41) supporting at least one piece of dental floss (12, 22, 32, 42), where said piece of floss (12, 22, 32, 42) defines at least one cleaning zone, wherein the main body (11, 21, 31, 41) has two separate support regions each configured to support the ends of a piece of floss (12, 22, 32, 42), in the form of protruding projections that extend away from a central portion. This device for oral hygiene is based on cleaning with dental floss, not being provided with any region forming a handle or the like since it does not require the use of hands during its use.

### CROSS-REFERENCES TO RELATED APPLICATIONS

None.

### STATEMENT REGARDING FEDERAL SPONSORED RESEARCH OR DEVELOPMENT

None.

### NAMES OF PARTIES TO A JOINT RESEARCH AGREEMENT

None.

### REFERENCE TO A “SEQUENCE LISTING”, A TABLE, OR A COMPUTER PROGRAM LISTING APPENDIX SUBMITTED ON COMPACT DISC AND INCORPORATION-BY-REFERENCE OF THE MATERIAL ON THE COMPACT DISCLOSURE

None.

### STATEMENT REGARDING PRIOR DISCLOSURES BY AN INVENTOR OR JOINT INVENTOR

None.

### BACKGROUND OF THE INVENTION

### 1. Field of the Invention

The present invention relates to oral hygiene, and more particularly, to an improved device for interdental hygiene with dental floss and without with any region forming a handle.

### 2. Description of Related Art Including Information Disclosed Under 37 CFR 1.97 and 37 CFR 1.98

As is known by experts in dental and/or oral hygiene, one of the best methods for dental hygiene is the use of interdental floss, since it enables any food remaining in the areas located between the teeth to be correctly removed in a simple, suitable way, preventing the formation of plaque or tartar, and therefore its consequences, in a much more effective manner.

In order to make it easier for the user to use the dental floss, so-called floss picks are known in the state of the art, essentially based on a rigid part, usually made of a plastic material, in the shape of an arch with a portion of taut dental floss between the two ends of said arch, making it much easier to place the floss between the teeth, especially in the innermost part of the mouth, rather than holding the floss with the hands at two ends to keep it taut.

However, as with the use of a toothbrush, it requires the use of the user's hands, so that the user can only carry out the activity related to dental hygiene, essentially due to the fact that they need the help of at least one of their hands to perform such activity. This fact necessarily limits the execution of the activity, be it the physical place, as well as the moment in time, since it cannot be carried at any moment due to the need to use the hands.

Moreover, all devices based on the use of dental floss are usually made of a polymer material, which is in no case edible, such that the user must be careful not to swallow it. Furthermore, it must subsequently be discarded, which forces the user to find a place to dispose of it or to keep it until they find a place to do so, with the drawback that it requires a space or support case for storing it until it is discarded.

Furthermore, the applicant is currently unaware of the existence of an invention having all the features described herein.

Other patents describing the closest subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### BRIEF SUMMARY OF THE INVENTION

The object of the present application is to register an oral hygiene device.

More specifically, the invention proposes the development of a device for oral hygiene and, more specifically, for interdental hygiene, being based on cleaning with dental floss, which is not provided with any region forming a handle or the like since it does not require the use of hands during its use. effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING

With the above and other related objects in view, the invention exists in the details of construction and combination of parts as will be more fully understood from the following description, when read in conjunction with the accompanying drawings in which:

FIG. 1 is a schematic perspective view of a first embodiment of the oral hygiene device of the invention.

FIG. 2 is a schematic view of the device represented in FIG. 1 arranged inside the mouth of a user.

FIG. 3 is a side elevation view of a second embodiment of the device according to the invention.

FIG. 4 is a perspective view of a third embodiment of the oral hygiene device according to the present invention.

FIG. 5 is a plan view of the device represented in FIG. 4.

FIG. 6 is a cross-sectional view of the support along the cut line A-A indicated in FIG. 5.

FIG. 7 is a perspective view of a fourth embodiment of the oral hygiene device according to the present invention.

FIG. 8 is an exploded perspective view of a fourth embodiment of the device according to the invention.

### DETAILED DESCRIPTION OF THE INVENTION

While this invention may be embodied in many different forms, there are described in detail herein specific embodiments of the invention. This description is exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of use is sometimes referred to as the device, the invention, the oral hygiene device, the machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

The present invention has been developed for the purpose of providing an oral hygiene device configured as a novelty in the field of the application and resolves the aforementioned drawbacks, also providing other additional advantages that will be evident from the accompanying description below.

An object of the present invention is therefore to provide an oral hygiene device, which comprises a main body not provided with a region forming a handle, with dimensions that allow the device to be completely inserted into the mouth area of a user, said main body supporting at least one piece of dental floss, where said piece of floss defines at least one cleaning zone, which is characterized in that the main body has two extensions or also referred to in this specification as separate support regions, each configured to support the ends of a piece of dental floss, in the form of protruding projections that extend away from a central portion.

Given these features, a device for dental hygiene based on cleaning with dental floss has been developed which can be used without the need to use hands, making it much more practical than the devices currently used for dental hygiene, which must necessarily be used with the help of at least one hand. Thus, the user can “play” inside the mouth with this device, moving it around the inside with the help of the tongue and muscular movements of the facial region. This fact advantageously allows the user to simultaneously perform a dental cleaning task and any other additional task, such as, for example, using or handling an electronic device, driving a vehicle, such that the advantages that this new device entails compared to traditional cleaning systems are evident.

Another equally advantageous aspect is the fact that, thanks to the small size thereof, it can be easily stored in a garment pocket, purse or bag, and it can be used multiple times after it is cleaned.

According to another feature of the invention, the main body can be formed from a core made of edible gum (which can contain an active ingredient), the core being coated with a hard thin layer of edible material.

In this way, because it is made of edible material, the user facilitates the use to the user since it is not necessary to remove it from the mouth once it has performed its function, given that the support will gradually dissolve inside the mouth as it is being used. The rigid outermost surrounding layer enables the usage time of the support to increase since otherwise the action of the dental floss would be difficult.

According to another aspect of the oral hygiene device, at least one of the two support regions includes a releasable coupling system envisaged to keep the dental floss fixed in a condition of use and envisaged to remove the dental floss from the support region. Due to these features, the user has the option of replacing the dental floss without having to discard the main body that makes up the device, which enables the useful life thereof to be extended.

In a preferred embodiment, the aforementioned releasable coupling system has a groove made in the top of the support region, the groove having a width such that the dental floss is press-fit, the ends of the floss including a widened portion. In this way, it is a system that is easy to manufacture for the manufacturer and easy to use for the user.

Alternatively, the releasable coupling system may have a plurality of grooves arranged in a cross shape made in an extension that projects from the top of the support region.

Preferably, the two support regions are provided with a releasable coupling system.

Advantageously, the main body includes at least one through hole. In this way, the amount of material needed to manufacture the main body can be reduced, and on the other hand, it acts as a safety means for the user in case they swallow it, since it prevents said user from choking due to the lack of air supply.

According to another aspect of the invention, the device of the invention includes a metal member present in any region of the main body. In this way, in the event that the user inadvertently swallows the device, it is possible to detect, for example, by means of X-rays, the location of the device inside the user's body given the presence of a detectable metal member. Thus, a health worker can decide whether or not there is a risk to the user.

Advantageously, the main body is made from a single piece of injection-moldable material, which makes it easier to manufacture it and consequently reduces production costs.

The described oral hygiene device therefore represents an innovative structure with structural and constitutional features hitherto unknown for its intended purpose, reasons which, taken together with its usefulness, provide it with sufficient grounds for obtaining the requested exclusivity privilege.

In view of the mentioned drawings and according to the numbering used, the figures show a preferred embodiment of the invention, which comprises the parts and elements indicated and described in detail below.

### Example 1

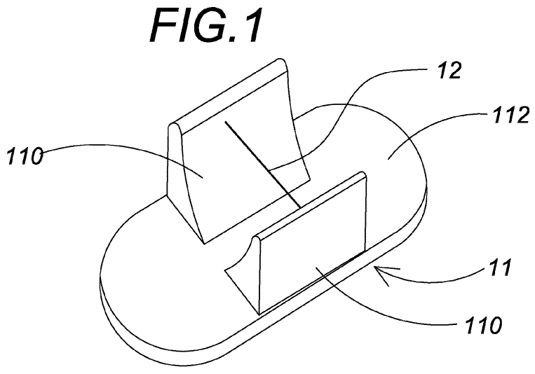

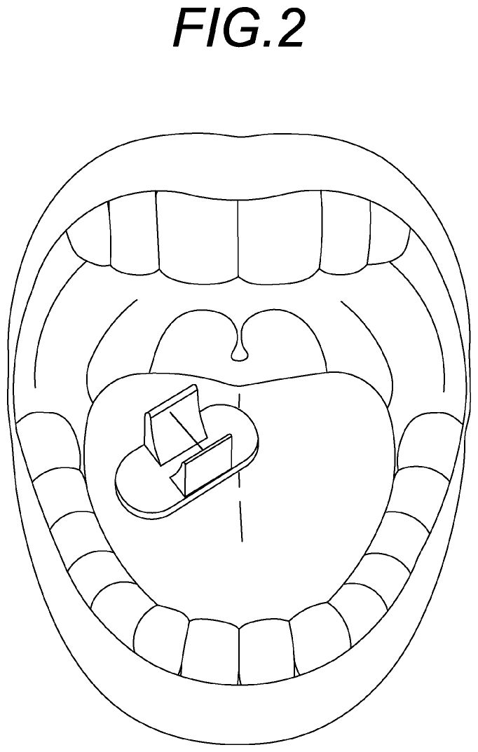

In this embodiment of the device of the invention, as represented in FIGS. 1 to 3, it comprises a main body (11) that has two support regions (110) spaced apart, which are configured to support and hold the ends of a piece of dental floss (12), the main body (11) having dimensions such that the support is capable of being inserted inside the mouth area of a user. As can be seen, it includes a section with a flat surface (112), which makes it easier to clean the teeth located in the rearmost portion of the oral region as the molars act as a support area. The dental floss in this case defines a single cleaning zone defined by a segment of dental floss (12) arranged between the two protruding projections or support regions (110) facing and separated from each other.

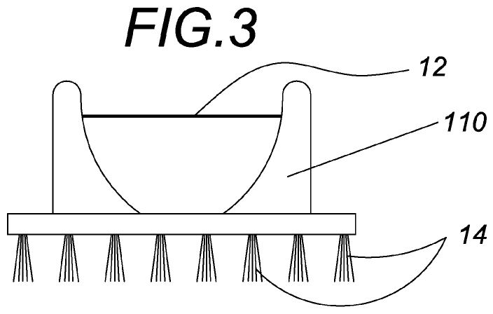

In FIG. 3, the device of the invention can additionally include a plurality of bristles (14) that protrude externally from the flat surface (112), which enable the dental area on which the body (11) rests to be cleaned simultaneously while the dental floss (12) is being used to clean other teeth.

### Example 2

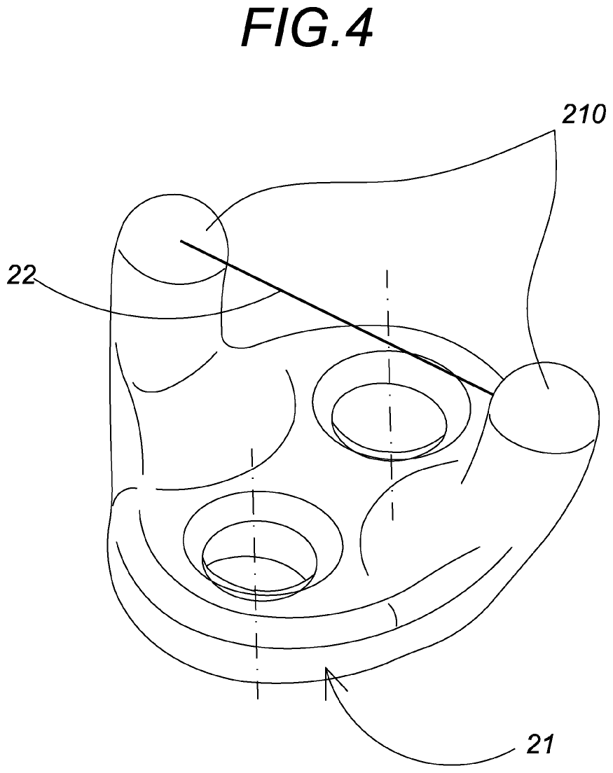

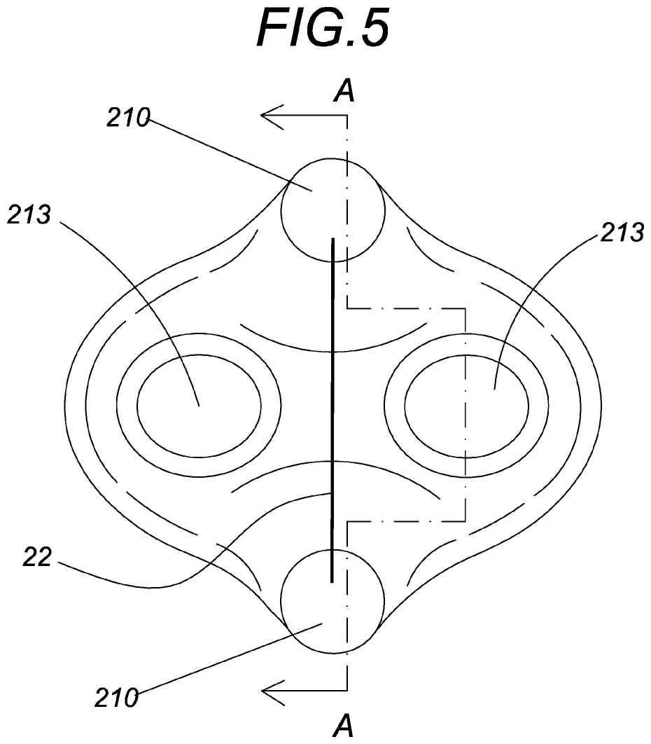

As can be seen in the embodiment of the oral hygiene device shown in FIGS. 4 and 5, it comprises a main body (21) that has two regions (210) spaced apart, which are configured to support and hold the ends of a piece of dental floss (22), the main body (21) having dimensions such that the support is capable of being inserted inside the mouth area of a user.

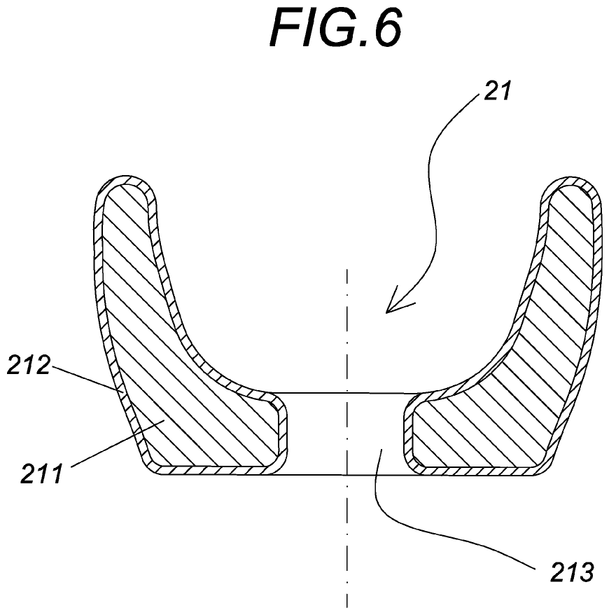

As can be seen in FIG. 6, the main body (21) is formed from a core (211) made of edible chewable gum base material (for example, of those used for manufacturing chewing gum for oral hygiene), being able to contain antimicrobial, anti-tartar or anti-plaque agents, the core (211) being coated with a hard thin outer layer (212), also made of an edible material (which can be crunchy).

Furthermore, the core (211) of the main body (21) has a flavoring or coloring and/or active ingredient, such as, for example, of the pharmaceutical, medicinal, nutritional or functional type, a toothpaste or breath freshener.

This device, therefore, also contributes to reducing the formation of cavities and gum disease, since it reduces the layer of bacteria that adheres to the surface of the teeth due to the composition of the core.

Furthermore, the main body (21) is made up of a flat region from which a pair of separate extensions protrude from one same surface, each one corresponding to a respective region (210) to hold the section of dental floss (22), as mentioned above.

It should be noted that the main body (21) additionally includes a pair of through holes (213) and it is not provided with sharp edges, such that it does not pose any risk to the user while it is being used.

### Example 3

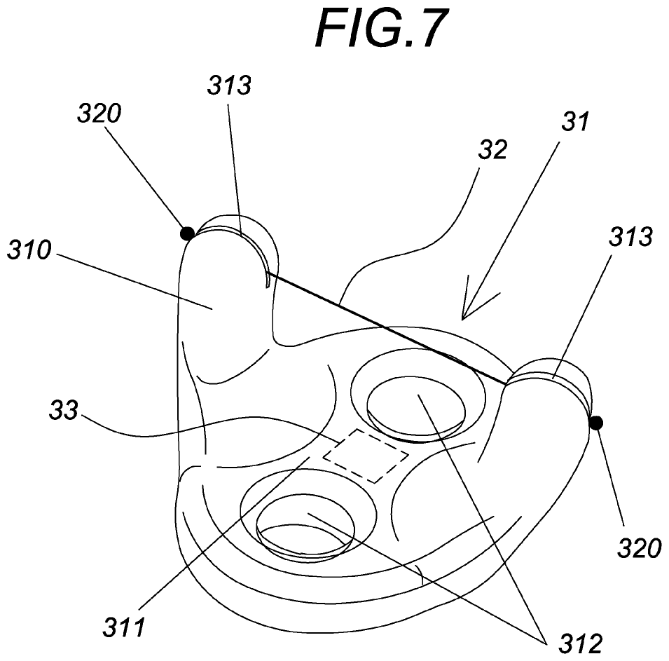

As can be seen in FIG. 7, the oral hygiene device comprises a main body (31), made from a single piece of injection-mouldable material, that has two support regions (310) spaced apart, which are configured to support and hold the ends of a piece of dental floss (32), the body having dimensions such that the support is capable of being inserted inside the mouth area of a user.

As can be seen, the main body (31) is made up of a flat region (311) from which a pair of separate extensions protrude from one same surface, each one corresponding to a support region (310) to hold a section of dental floss (32), the extensions of which protrude perpendicular relative to the flat region (311).

Each of the support regions (310) includes a releasable coupling system envisaged to keep the dental floss (32) fixed in a condition of use and envisaged to remove the dental floss (32) relative to the support region.

Going into greater detail, the releasable coupling system has a single groove (313) that crosses the entire width of the support region made in the top of the support region (310), the groove (313) having a width such that the dental floss is press-fit, the ends of the dental floss (32) including a widened portion (320) or additional member that has a greater thickness or diameter than the dental floss (32), envisaged to ensure that the dental floss (32) does not easily release from the groove (313).

It should be noted that the main body (31) additionally includes a pair of through holes (312) and it is not provided with sharp edges, such that it does not pose any risk to the user while it is being used inside the mouth or if it is inadvertently swallowed by said user.

Additionally, the main body can include a metal member (33) (represented by dashed lines) present in any area thereof, preferably housed inside the main body (31), which enables it to be detected by suitable metal detection means, such as, for example, a conventional X-ray device commonly used in the medical field. This metal member (33) can be inserted inside during the manufacturing process, for example, by means of the injection overmolding technique.

### Example 4

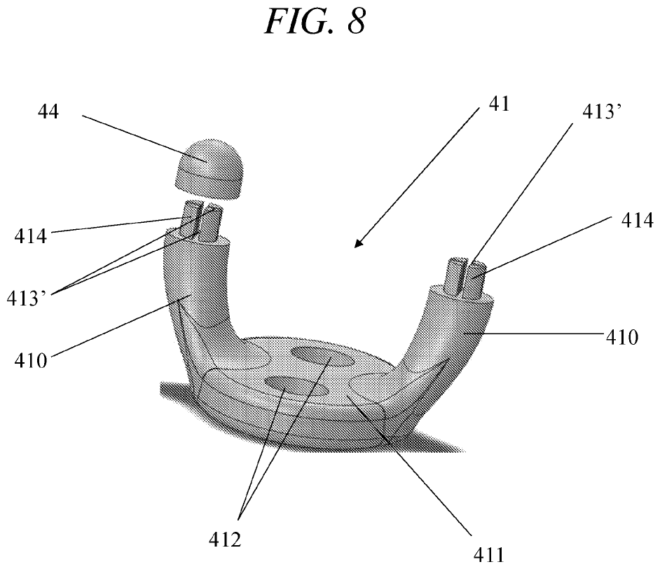

FIG. 8 shows a fourth embodiment of the oral hygiene device. The main difference in this second embodiment is that the releasable coupling system for the dental floss (42) has multiple grooves (413′) that adopt a cross-shaped arrangement made in a protruding extension (414) that protrudes from the top of each support region (410).

Additionally, in this fourth example, the device can include a protective cap (44) that can be coupled by snap fit at the top of each support region (410) that forms part of the main body (41).

The main body (41) additionally includes a pair of through holes (412) located in the flat region (411) and it is not provided with sharp edges, such that it does not pose any risk to the user while it is being used inside the mouth or if it is inadvertently swallowed by said user.

The details, shapes, dimensions and other accessory elements used to manufacture the oral hygiene device of the invention may be suitably substituted for others which do not diverge from the scope defined by the claims included below.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

I/We claim:

1. An oral hygiene device, which comprises a main body not provided with a region forming a handle, with dimensions that allow the device to be completely inserted into the mouth area of a user, said main body (11, 21, 31, 41) supporting at least one piece of dental floss (12, 22, 32, 42), where said piece of floss (12, 22, 32, 42) defines at least one cleaning zone, the main body (11, 21, 31, 41) having two separate support regions each configured to support the ends of a piece of floss (12, 22, 32, 42), in the form of protruding projections that extend away from a central portion, characterized in that the main body (11, 21, 31, 41) is made from a single piece, the central portion having a flat surface that includes at least one through hole;
wherein the support regions protrude perpendicular relative to the central portion;
the two support regions being provided with a releasable coupling system envisaged to keep the dental floss (12, 22, 32, 42) fixed in a condition of use and envisaged to remove the dental floss from the support region.

2. The oral hygiene device according to claim 1, characterized in that the main body (11, 21, 31, 41) is not provided with sharp edges.

3. The oral hygiene device according to claim 1, characterized in that each of the projections or support regions has a termination with a curved shape.

4. The oral hygiene device according to claim 1, characterized in that the main body (11, 21, 31, 41) is made of an injection-moldable material.

5. The oral hygiene device according to claim 1, characterized in that it includes a plurality of bristles that protrude externally from the flat surface.

6. The oral hygiene device according to claim 1, characterized in that the main body (11, 21, 31, 41) is formed from a core made of an edible material, the core being coated with a hard thin layer of edible material.

7. The oral hygiene device according to claim 6, characterized in that the core is made of chewable gum base material.

8. The oral hygiene device according to claim 6, characterized in that the core of the main body (11, 21, 31, 41) contains an active ingredient.

9. The oral hygiene device according to claim 8, characterized in that the active ingredient is of the pharmaceutical, medicinal, nutritional or functional type, a toothpaste or breath freshener.

10. The oral hygiene device according to claim 1, characterized in that the releasable coupling system has a groove made in the top of the support region, the groove having a width such that the dental floss is press-fit, the ends of the floss including a widened portion.

11. The oral hygiene device according to claim 1, characterized in that the releasable coupling system has a plurality of grooves arranged in a cross shape made in a projecting extension that protrudes from the top of each support region.

12. The oral hygiene device according to any of preceding claim 1, characterized in that it includes a metal member (33) present in any area of the main body (11, 21, 31, 41).

13. The oral hygiene device according to claim 2, characterized in that the main body (11, 21, 31, 41) is made of an injection-moldable material.

14. The oral hygiene device according to claim 3, characterized in that the main body (11, 21, 31, 41) is made of an injection-moldable material.

15. The oral hygiene device according to claim 2, characterized in that it includes a plurality of bristles that protrude externally from the flat surface.

16. The oral hygiene device according to claim 3, characterized in that it includes a plurality of bristles that protrude externally from the flat surface.

17. The oral hygiene device according to claim 4, characterized in that it includes a plurality of bristles that protrude externally from the flat surface.

18. The oral hygiene device according to any of preceding claim 2, characterized in that it includes a metal member (33) present in any area of the main body (11, 21, 31, 41).

19. The oral hygiene device according to any of preceding claim 3, characterized in that it includes a metal member (33) present in any area of the main body (11, 21, 31, 41).

20. The oral hygiene device according to any of preceding claim 4, characterized in that it includes a metal member (33) present in any area of the main body (11, 21, 31, 41).

21. The oral hygiene device according to any of preceding claim 5, characterized in that it includes a metal member (33) present in any area of the main body (11, 21, 31, 41).

22. The oral hygiene device according to any of preceding claim 6, characterized in that it includes a metal member (33) present in any area of the main body (11, 21, 31, 41).

23. The oral hygiene device according to any of preceding claim 7, characterized in that it includes a metal member (33) present in any area of the main body (11, 21, 31, 41).

24. The oral hygiene device according to any of preceding claim 8, characterized in that it includes a metal member (33) present in any area of the main body (11, 21, 31, 41).

25. The oral hygiene device according to any of preceding claim 9, characterized in that it includes a metal member (33) present in any area of the main body (11, 21, 31, 41).

26. The oral hygiene device according to any of preceding claim 10, characterized in that it includes a metal member (33) present in any area of the main body (11, 21, 31, 41).

27. The oral hygiene device according to any of preceding claim 11, characterized in that it includes a metal member (33) present in any area of the main body (11, 21, 31, 41).
